(19) United States
(12) Patent Application Publication
(10) Pub. No.: US 2020/0198509 A1
(43) Pub. Date: Jun. 25, 2020

(54) CHILD SEAT ASSEMBLY

(71) Applicant: Mahle International GmbH, Stuttgart (DE)

(72) Inventors: Michael Conze, Tuebingen (DE); Franziska Erhardt, Stuttgart (DE); Matthias Ganz, Stuttgart (DE); Yvonne Maier, Korntal-Muenchingen (DE); Mario Wallisch, Aichtal (DE)

(21) Appl. No.: 16/721,907

(22) Filed: Dec. 19, 2019

(30) Foreign Application Priority Data
Dec. 20, 2018 (DE) 102018222477.3

(51) Int. Cl. B60N 2/56; B60N 2/26

(52) U.S. Cl. CPC B60N 2/5657; B60N 2/26

(57) ABSTRACT

A child seat assembly for a vehicle is disclosed. The child seat assembly includes a seat cover and an air conditioning module including a fan. The fan is structured and arranged to couple to the seat cover to guide air, and such that air conveyed by the fan can flow through the seat cover. The seat cover has an air-guiding inner layer, an outer layer, and a bottom layer, with the air-guiding inner layer arranged between the outer layer and the bottom layer. The seat cover has a hem that laterally closes the inner air-guiding layer. At least one outlet opening, through which air can flow, is provided in the hem, such that the air flowing out of the seat cover flows through the at least one outlet opening.

### CROSS-REFERENCE TO RELATED APPLICATION

This application claims priority to German Application No. DE 10 2018 222 477.3 filed on Dec. 20, 2018, the contents of which are hereby incorporated by reference in its entirety.

### TECHNICAL FIELD

The invention relates to a child seat assembly for a vehicle.

### BACKGROUND

The state-of-the-art air conditioning systems in a motor vehicle comprise ventilated seats for adults—as they are known, for example, from US 2009218855 A1; U.S. Pat. No. 8,944,145 B2 or US 2016076830 A1.

Child seats—as they are known, for example, from DE 102012021064 A1—can also be ventilated. However, child seats are not actively air conditioned, so that children—ranging from newborns to school-aged children—sweat on the back or on the head in the summer and feel uncomfortable in a cold child seat in the winter in spite of the ventilation. The child seat thus has to reach a comfortable contact temperature as quickly as possible. When sitting for a longer period of time, heat and/or moisture accumulations have to further be avoided in the child seat. This problem cannot be solved by means of a conventional air conditioning system in the motor vehicle or a thermoelectric seat cover.

It is thus the object of the invention to specify an improved or at least alternative embodiment for a child seat assembly of the generic type, in the case of which the described disadvantages are overcome.

### SUMMARY

This object is solved according to the invention by the subject matter of the independent claim(s). Advantageous embodiments are subject matter of the dependent claims.

A child seat assembly according to the invention for a vehicle has a seat cover and an air conditioning module comprising a fan. The fan of the air conditioning module can thereby be coupled to the seat cover so as to guide air, and air conveyed by the fan can flow through the seat cover. The seat cover thereby has an air-guiding inner layer, an outer layer, and a bottom layer, wherein the inner layer is arranged between the outer layer and the bottom layer. The seat cover additionally has a hem, which laterally closes the inner layer. According to the invention, at least one outlet opening, through which air can flow, is formed in the hem, so that the air flowing out of the seat cover can flow through the at least one outlet opening. The heat as well as the moisture can be discharged from the seat cover through the outlet opening provided in the hem. The hem thereby laterally closes the air-guiding inner layer, the at least one outlet opening can thereby be arranged laterally or can be aligned towards the outer layer. Independently thereof, the at least one outlet opening is not covered by the sitting child, so that, regardless of the sitting position of the child, an optimal ventilation of the seat cover can be attained. Heat and/or moisture accumulations in the seat cover can thus be avoided, and a sufficient thermal comfort can be offered to children. The air conditioning module can advantageously also have a temperature control unit, which can control the temperature of the air conveyed by the fan.

The hem can advantageously be formed by the bottom layer, which is secured to the outer layer. The bottom layer then laterally encompasses the inner layer and thus closes it laterally. The bottom layer can thereby additionally also laterally encompass the outer layer. Alternatively, the hem can be a separate element, which is secured to the outer layer and to the bottom layer, and which laterally encompasses and thus laterally closes the inner layer. Alternatively, the hem can be a separate element, which is secured to the outer layer and to the bottom layer, and which encompasses and thus laterally closes the inner layer, the outer layer, and the bottom layer.

Advantageously, the outer layer is water-permeable. The moisture can thus reach through the outer layer into the inner layer and can be discharged from the latter. The outer layer can thereby be air-permeable or air-impermeable. Whether the outer layer is air-permeable or air-impermeable can be adapted, for example, to the users' feeling of comfort. It is known, for example, that an outflow of air from the seat cover can be perceived to be comfortable or uncomfortable, depending on country. The outer layer can thereby be, for example, semi-permeable and can only allow water to pass through. Alternatively, the outer layer can, for example, be air-tight and can introduce the water into the inner layer by capillary action. The bottom layer can be air-permeable as well as air-impermeable in the same way.

Advantageously, the at least one outlet opening in the hem can be formed by an air-permeable area of the otherwise air-tight hem. The air-permeable area can thereby be realized, for example, by a different material than the hem per se. Alternatively, the at least one outlet opening in the hem can be formed by the hem, which is air-permeable per se. Alternatively, the at least one outlet opening can penetrate the hem and can expose the air-guiding inner layer to the outside.

In the case of the at least one outlet opening penetrating the hem, it can be provided that a circumferential sleeve, which can be flown through, is arranged in said outlet opening. An area of the hem including the outlet opening thereby encloses the circumferential sleeve from the outside, so that the at least one outlet opening can be flown through through the circumferential sleeve. The shape and the cross section of the at least one outlet opening, which can be flown through, are thus determined by the shape and the cross section, which can be flown through, of the circumferential sleeve arranged in said outlet opening. The circumferential sleeve is advantageously formed to be dimensionally stable, so that a blocking of the at least one outlet opening and a resulting redistribution of the air flowing through in the seat cover can be prevented. The circumferential sleeve can thus be made, for example, of an elastomeric or of a thermoplastic material in an injection molding process. Other materials and production methods, however, are generally also conceivable.

In the case of the further development of the circumferential sleeve, it can be provided that the cross section of the circumferential sleeve, which can be flown through, is round or oval or rectangular or polygonal. Alternatively, a plurality of adjacent sleeve openings inside the circumferential sleeve can in each case be separated from one another by means of a separating wall, so that the cross section of the circumferential sleeve, which can be flown through, consists of round or oval or rectangular or polygonal cross sections of the respective sleeve openings, which can be flown through. In addition, the separating wall can additionally stabilize the circumferential sleeve. Regardless of the design of the circumferential sleeve, the cross section thereof, which can be flown through, can be adapted to the desired distribution of the air, which flows through, in the seat cover.

In the case of an advantageous embodiment of the child seat assembly, it is provided that the seat cover has at least two outlet openings. The outlet openings are then arranged spaced apart from one another in the hem. The respective outlet openings in the seat cover can be identical thereby or can have a differing shape and/or a differing cross section. The moisture can be discharged particularly effectively from the seat cover through the two or also a plurality of outlet openings, and the desired distribution of the air, which flows through, can be attained in a simplified manner in the seat cover. A circumferential sleeve can additionally be arranged in each of the outlet openings. If the respective outlet openings in the seat cover have a differing shape and/or a differing cross section, this can then be realized by means of a differing shape and/or a differing cross section of the respective circumferential sleeves. If the respective outlet openings are identical, this can be realized accordingly by means of the identically designed circumferential sleeves.

It can additionally be provided that at least one blocking element, preferably a seam or an embossing, is arranged in the air-guiding inner layer. The at least one blocking element then divides the inner layer into flow ducts, which are separated from one another at least in some areas. In other words, the at least one blocking element laterally limits the flow ducts in the inner layer, wherein the flow ducts inside the inner layer and outside of the blocking element can also be connected to one another so as to guide air. The blocking element can thus also be considered to be a guide element or a separating wall.

Advantageously, the respective flow ducts can extend at least in some areas from an air inlet of the inner layer to the respective outlet opening. The air can then be systematically guided from the air inlet of the inner layer to the respective outlet opening through the respective flow ducts. The air inlet of the inner layer is advantageously connected to the air conditioning module so as to guide air, so that the air conveyed by the fan enters into the inner layer at the air inlet. The air inlet can thereby be formed by at least one inlet opening, which is connected to the respective outlet opening in the hem so as to guide air via the respective flow ducts, which are limited by the at least one blocking element. Alternatively, the air inlet of the seat cover can also comprise a plurality of inlet openings.

It can advantageously be provided that the respective flow ducts have a differing shape and/or a differing length and/or a differing width and/or a differing alignment. The flow ducts are thereby advantageously adapted to the desired distribution of the air, which flows through, in the seat cover. Advantageously, a plurality of blocking elements can be arranged in the air-guiding inner layer. A plurality of flow ducts can accordingly also be formed in the seat cover by means of the respective blocking elements. At least some of the blocking elements can thereby have a differing shape and/or a differing length and/or a differing alignment and/or a differing distance to an air inlet of the seat cover. The blocking elements and the flow ducts in the seat cover formed thereby are thus advantageously adapted to the desired distribution of the air, which flows through, in the seat cover.

Further important features and advantages of the invention follow from the subclaims, from the drawings, and from the corresponding figure description on the basis of the drawings.

It goes without saying that the above-mentioned features, and the features, which will be described below, cannot only be used in the respective specified combination, but also in other combinations or alone, without leaving the scope of the present invention.

Preferred exemplary embodiments of the invention are illustrated in the drawings and will be described in more detail in the following description, wherein identical reference numerals refer to identical or similar or functionally identical components.

### BRIEF DESCRIPTION OF THE DRAWINGS

In each case schematically,

FIG. 1 shows a child seat assembly according to the invention in section with a child sitting on it;

FIG. 2 shows a view of the child seat assembly on an outlet opening;

FIG. 3 shows a view of the child seat assembly at the outlet opening comprising a circumferential sleeve;

FIG. 4 shows a sectional view of the child seat assembly at the outlet opening comprising the circumferential sleeve;

FIGS. 5 to 8 show sectional views of the circumferential sleeves of varying designs;

FIGS. 9 to 13 show views of the child seat assembly comprising a differing distribution of the air, which flows through.

### DETAILED DESCRIPTION

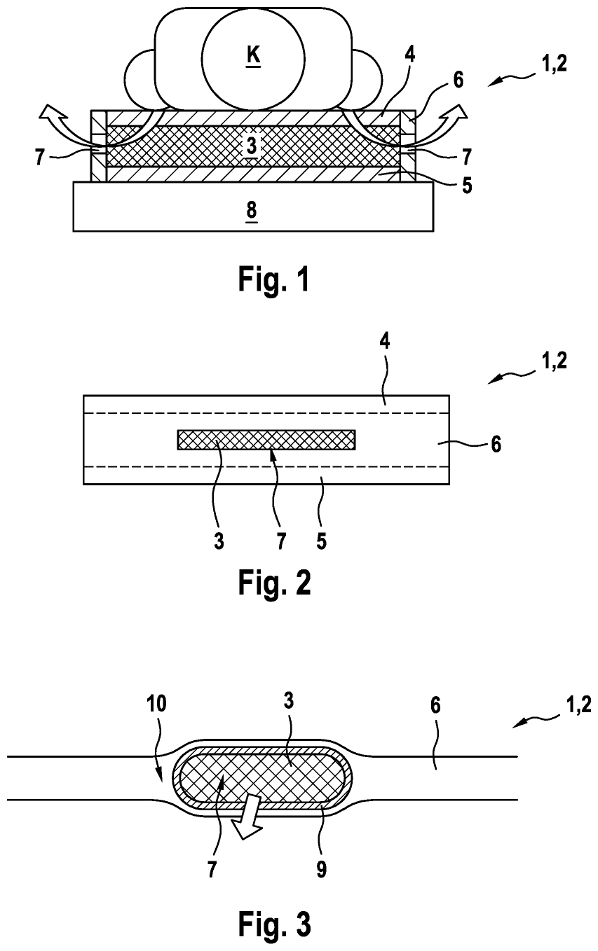

FIG. 1 shows a child seat assembly 1 according to the invention for a vehicle in section with a child K sitting on it. The child seat assembly 1 thereby comprises a seat cover 2 and an air conditioning module—not shown here—comprising a fan. The fan of the air conditioning module can thereby be coupled to the seat cover 2 so as to guide air, and air can flow through the seat cover 2. The seat cover 2 comprises an air-guiding inner layer 3, an air-permeable outer layer 4, and an air-impermeable bottom layer 5. The inner layer 3 is thereby arranged between the outer layer 4 and the bottom layer 5 and is laterally closed by a hem 6 in an air-tight manner. Outlet openings 7, through which air can flow, are formed in the hem 6, so that the air flowing out of the seat cover 2 can flow through the outlet openings 7. The seat cover 2 is arranged on a child seat 8, so that a corresponding thermal comfort is offered to the child K in the child seat 8. The outer layer 4 is thereby not only permeable for the air, but also for the moisture, so that the moisture can reach into the inner layer 3 via the outer layer 4. The moisture absorbed by the inner layer 3 can thereby be discharged from the seat cover 2 through the outlet openings 7 with the air, which flows through, as is suggested by means of arrows.

The outlet openings 7 thereby remain open, regardless of the sitting position of the child K, so that an optimal ventilation of the seat cover 2 is attained at any point in time. Heat and/or moisture accumulations in the seat cover 2 can thus be avoided in an advantageous manner, and a sufficient thermal comfort can be offered to the child K.

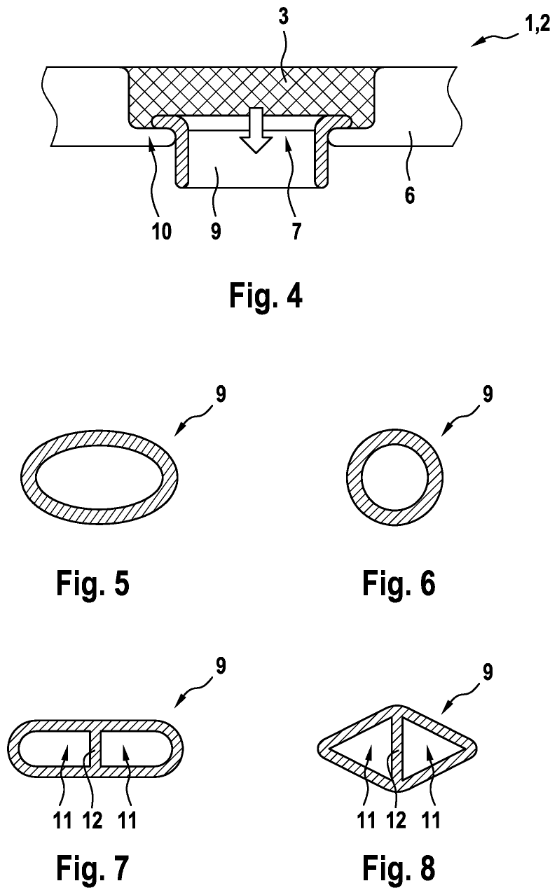

FIG. 2 shows a side view of the child seat assembly 1 at the outlet opening 7. Here, the hem 6 encompasses the inner layer 3, the outer layer 4, and the bottom layer 5, and closes them laterally. The outlet opening 7 is formed here by an air-permeable area of the hem 6. FIG. 3 shows a view and FIG. 4 shows a sectional view of the child seat assembly 1 at the outlet opening 7, in which a circumferential sleeve 9 is arranged. The outlet opening 7 thereby penetrates the hem 6 and is dimensionally stabilized by means of the circumferential sleeve 9, which can be flown through. For this purpose, the circumferential sleeve 9 is formed to be dimensionally stable and advantageously prevents a blocking of the outlet opening 7 and a redistribution of the air flowing through in the seat cover 2 resulting therefrom. An area 10 of the hem 6 including the outlet opening 7 thereby encloses the circumferential sleeve 9 from the outside, and the outlet opening 7 can be flown through through the circumferential sleeve 9. The shape and the cross section of the outlet opening 7, which can be flown through, are consequently determined by the shape and the cross section of the circumferential sleeve 9, which can be flown through.

FIG. 5 shows a sectional view of the circumferential sleeve 9, which has an oval cross section, which can be flown through. Deviating from this, the circumferential sleeve 9 in FIG. 6 has a round cross section, which can be flown through. Sectional views of the circumferential sleeves 9 of varying designs are shown in FIG. 7 and in FIG. 8. Two adjacent sleeve openings 11, which are separated from one another by means of a separating wall 12, are arranged inside the circumferential sleeves 9 here. The separating wall 12 additionally stabilizes the respective circumferential sleeve 9. The cross section of the respective circumferential sleeve 9, which can be flown through, consists of the cross sections of the respective sleeve openings 11, which can be flown through. Regardless of the design of the circumferential sleeve 9, the cross section thereof, which can be flown through, can be adapted to the desired distribution of the air, which flows through, in the seat cover 2. The circumferential sleeves 9 shown in FIG. 7 and FIG. 8 each have two sleeve openings 11. The circumferential sleeve 9 can generally also have a differing number of sleeve openings 11. The sleeve openings 11 can further have a shape, which differs from the shapes of the sleeve openings 11 shown here.

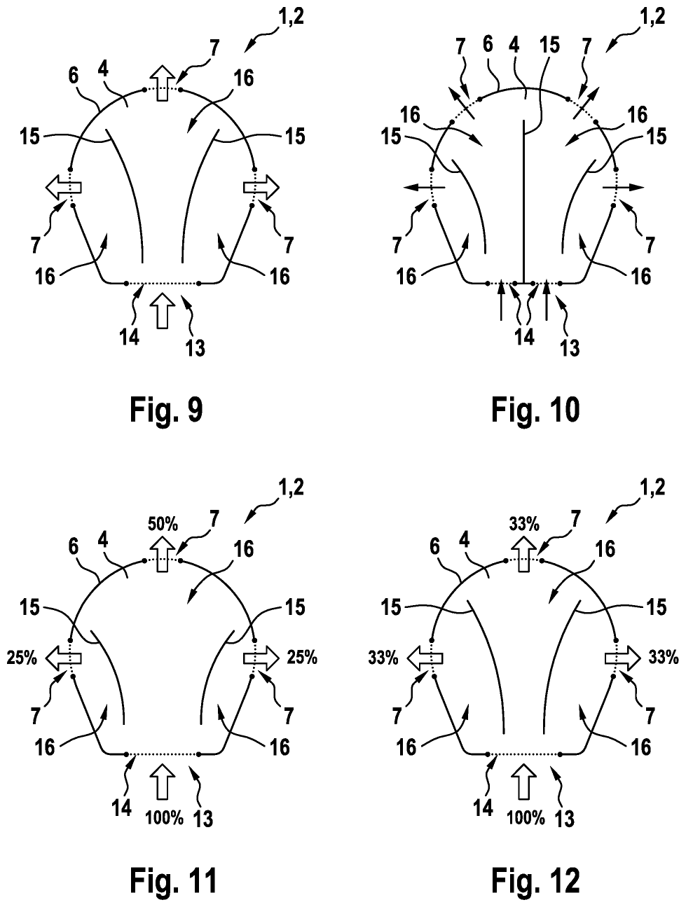

FIG. 9 to FIG. 13 show views of the child seat assembly 1 comprising a differing distribution of the air, which flows through, in the seat cover 2. A view of the seat cover 2 comprising three outlet openings 7, which are formed spaced apart from one another in the hem 6, is shown in FIG. 9. Air thereby flows through the seat cover 2 from an air inlet 13 comprising a single inlet opening 14 to the respective outlet openings 7, as is suggested by means of arrows. Two blocking elements 15—for example separating walls, seams, embossings or guide elements—which divide the inner layer 3 into three flow ducts 16, are additionally arranged in the seat cover 2. The respective flow ducts 16 lead from the air inlet 13 or from the inlet opening 14, respectively, to the respective outlet openings 7, so that moisture can be discharged efficiently and evenly from the seat cover. The respective flow ducts 16 inside the seat cover 2 are thereby connected to one another at the hem 6 and at the air inlet 13 so as to guide air. Deviating therefrom, the seat cover 2 in FIG. 10 has the air inlet 13 comprising two inlet openings 14. The seat cover 2 further has a total of four outlet openings 7, three blocking elements 15, and four flow ducts 16. Here, the respective flow ducts 16 are connected to one another at the hem 6 and in pairs at the air inlet 13 so as to guide air. It goes without saying that the supports 2 shown here are only exemplary. Fewer than two or more than three blocking elements 15 can generally also be arranged in the seat cover 2, and the inner layer 3 can accordingly be divided into fewer than three or into more than four flow ducts 16. The air inlet 13 can also have a differing number of the inlet openings 14.

FIG. 11 now shows a view of the seat cover 2 comprising an uneven distribution of the air, which flows through, at the outlet openings 7. At the lateral outlet openings 7, approximately 25%, and at the outlet opening 7 located opposite the air inlet 13, approximately 50% of the air, which flows through the air inlet 13 to the outlet openings 7, escapes. In the seat cover 2, this is attained by means of a differing width of the respective flow ducts 16. By way of comparison, a view of the seat cover 2 comprising the even distribution of the air, which flows through, is shown in FIG. 12. The flow ducts 16 are designed in such a way here that approximately 33% of the air, which flows into the air inlet 13, escapes at each outlet opening 7. Only the distribution of the air, which flows to the outlet openings 7, is shown in FIG. 11 and FIG. 12. If the outer layer 4 and/or the bottom layer 5 are air-permeable, only a portion of the air, which flows into the seat cover 2 in total, flows out of the outlet openings 7. It goes without saying that the distribution of the air, which flows through the air inlet 13 to the outlet openings 7, shown here, is only exemplary. Other distributions of the air, which flows through the air inlet 13 to the outlet openings 7, can generally also be realized in the seat cover 2.

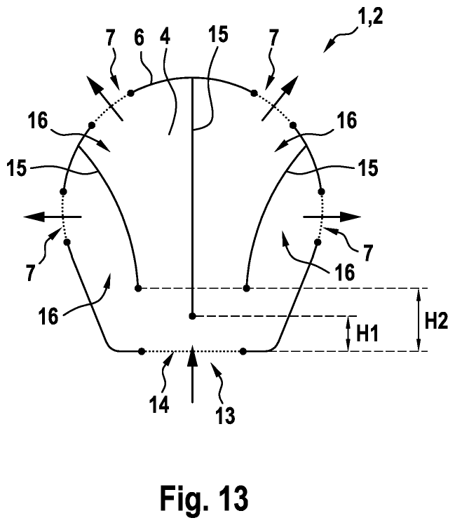

FIG. 13 now shows a view of the seat cover 2 comprising the flow ducts 16 of varying designs or comprising the blocking elements 15 of varying designs, respectively. Here, the flow ducts 16 are not connected to one another so as to guide air at the hem 6, so that the air is forced into the respective outlet openings 7. The blocking elements 15 further have a differing distance H1 and H2 to the air inlet 13 of the seat cover 2.

In summary, the child seat assembly 1 according to the invention can offer a high thermal comfort to a child K in the summer as well as in the winter. The heat and/or moisture accumulations in the seat cover 2 can in particular be prevented and an optimal distribution of the air, which flows through, can be attained in the seat cover 2.

1. A child seat assembly for a vehicle, comprising:
a seat cover and an air conditioning module including a fan,
wherein the fan of the air conditioning module is structured and arranged to couple to the seat cover to guide air, and such that air conveyed by the fan can flow through the seat cover,
wherein the seat cover has an air-guiding inner layer, an outer layer, and a bottom layer, wherein the air-guiding inner layer is arranged between the outer layer and the bottom layer,
wherein the seat cover has a hem that laterally closes the air-guiding inner layer, and
at least one outlet opening, through which air can flow, is provided in the hem, such that air flowing out of the seat cover flows through the at least one outlet opening.

2. The child seat assembly according to claim 1, wherein one of:
the at least one outlet opening in the hem is provided by an air-permeable area in an otherwise air-tight hem, and
the at least one outlet opening in the hem is provided by the hem being air-permeable per se.

3. The child seat assembly according to claim 1, wherein the at least one outlet opening penetrates the hem and exposes the air-guiding inner layer to an outside.

4. The child seat assembly according to claim 3, further comprising a circumferential sleeve, which can be flown through, arranged in the at least one outlet opening, wherein an area of the hem including the at least one outlet opening encloses the circumferential sleeve from the outside, such that the at least one outlet opening can be flown through via the circumferential sleeve.

5. The child seat assembly according to claim 4, wherein at least one of:
a flow cross section of the circumferential sleeve is one of round, oval, rectangular, and polygonal, and
a plurality of adjacent sleeve openings are provided inside the circumferential sleeve and in each case separated from one another via a separating wall, such that a flow cross section of the circumferential sleeve is provided by one of a round cross section, an oval cross section, a rectangular cross section, and a polygonal cross section of the plurality of sleeve openings, respectively.

6. The child seat assembly according to claim 1, wherein the seat cover has at least two outlet openings, the at least two outlet openings arranged spaced apart from one another in the hem.

7. The child seat assembly according to claim 6, wherein the at least two outlet openings are identical or have at least one of a differing shape and a differing cross section.

8. The child seat assembly according to claim 6, further comprising at least one blocking element disposed in the air-guiding inner layer structured and arranged to divide the air-guiding inner layer into a plurality of flow ducts that are separated from one another in an air-tight manner at least in some areas.

9. The child seat assembly according to claim 8, wherein the plurality of flow ducts respectively extend at least in some areas from an air inlet of the air-guiding inner layer to the at least two outlet openings, such that moisture present in the seat cover is guided via the plurality of flow ducts to the at least two outlet openings.

10. The child seat assembly according to claim 8, wherein the plurality of flow ducts respectively have at least one of a differing shape, a differing length, a differing width, and a differing alignment from one another.

11. The child seat assembly according to claim 8, wherein:
the at least one blocking element includes a plurality of blocking elements arranged in the air-guiding inner layer, and
at least some of the plurality of blocking elements have at least one of a differing shape, a differing length, a differing alignment, and a differing distance to an air inlet of the seat cover.

12. The child seat assembly according to claim 1, wherein one of:
the hem is provided by the bottom layer, and the bottom layer is secured to the outer layer and laterally encompasses the air-guiding inner layer and closes the air-guiding inner layer laterally,
the hem is a separate element that is secured to the outer layer and to the bottom layer, and the hem laterally encompasses and laterally closes the air-guiding inner layer, and
the hem is a separate element that is secured to the outer layer and to the bottom layer, and the hem laterally encompasses and laterally closes the air-guiding inner layer, the outer layer, and the bottom layer.

13. The child seat assembly according to claim 1, wherein the outer layer is air-permeable and water-permeable.

14. The child seat assembly according to claim 1, wherein the outer layer is air-impermeable and water-permeable.

15. The child seat assembly according to claim 2, wherein the hem is provided by the bottom layer, and the bottom layer is secured to the outer layer and laterally encompasses the air-guiding inner layer to laterally close the air-guiding inner layer.

16. The child seat assembly according to claim 3, wherein the at least one outlet opening includes at least two outlet openings arranged spaced apart from one another in the hem.

17. The child seat assembly according to claim 8, wherein the least one blocking element is a seam arranged in air-guiding inner layer.

18. The child seat assembly according to claim 8, wherein the least one blocking element is an embossing arranged in air-guiding inner layer.

19. The child seat assembly according to claim 9, wherein the plurality of flow ducts have at least one of a differing shape, a differing length, a differing width, and a differing alignment from one another.

20. A child seat assembly for a vehicle, comprising:
a seat cover;
an air conditioning module including a fan, wherein the fan is structured and arranged to couple to the seat cover to guide air and such that air conveyed by the fan flows through the seat cover;
the seat cover including an air-guiding inner layer, a water-permeable outer layer, and a bottom layer, wherein the air-guiding inner layer is arranged between the water-permeable outer layer and the bottom layer;
the seat cover further including a hem that laterally closes the air-guiding inner layer;
wherein the seat cover has at least two outlet openings disposed in the hem such that air flowing out of the seat cover flows through the at least two outlet openings; and
wherein the at least two outlet openings are arranged spaced apart from one another in the hem, and the at least two outlet openings have at least one of a differing shape and a differing cross section from one another.
